(19) United States
(12) Patent Application Publication
(10) Pub. No.: US 2022/0156342 A1
(43) Pub. Date: May 19, 2022

(54) SYSTEM AND METHOD FOR DETERMINING CORRELATION BETWEEN A CONTENT AND A PLURALITY OF RESPONSES

(71) Applicant: Zensar Technologies Limited, Pune (IN)

(72) Inventors: Sandeep Kishore, Fremont, CA (US); Sumant Kulkarni, Pune (IN); Mukul Tiwari, Pune (IN); Hari Eswar S M, Pune (IN); Aishwarya Chaurasia, Pune (IN); Richa Sawhney, Pune (IN); Shree Krishna Somani, Pune (IN)

(21) Appl. No.: 17/099,918

(22) Filed: Nov. 17, 2020

(51) Int. Cl. G06F 17/15; G06N 20/00; G06F 16/9536

(52) U.S. Cl. CPC G06F 17/153; G06Q 50/01; G06F 16/9536; G06N 20/00

(57) ABSTRACT

A system and method for determining a correlation between a content and a plurality of responses corresponding to the content shared on a communication platform is disclosed. The system may be configured for filtering a set of responses from the plurality of responses based upon interaction analysis of each user providing the response in view of prior engagement data and participation data on the communication platform, and content analysis corresponding to historical contents, on the communication platform, of each user providing the response. The system may further configured for extracting multidimensional behaviour data and performing an analysis on the multidimensional behaviour data of the content and each response of the set of responses corresponding to the content. Further, the system may be configured for deriving insights such as identification of an improvement areas, a context and an audience or a group of users.

### CROSS-REFERENCE TO RELATED APPLICATIONS AND PRIORITY

The present application does not claim priority from any other patent application.

### TECHNICAL FIELD

The present subject matter described herein generally relates to content processing, and more particularly, relates to a system and a method for determining a correlation between a content and a plurality of responses corresponding to the content shared on a communication platform.

### BACKGROUND

The subject matter discussed in the background section should not be assumed to be prior art merely because of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Social media campaigns are essential marketing platform for many businesses, as nowadays everyone is sharing and responding over social communication platforms. However, social media presence does not provide guarantied success. Therefore, it is essential to track reviews of users or audiences to get better insights about success and failure of the product in the marketplace.

Further, there is a need to promote strategic conversations in large organization where associates interact through various communication platforms. There is need of strategic leadership for better business performance and implement effective change management while understanding the alignment of the associates with the company's values.

Few existing systems employ a method of calculating a social sentiment score for an event or a topic based upon normalizing the sentiment of the user over time. However, these systems are suppressing individual opinion with respect to mass opinion. These systems are mainly focusing on the sentiment of the users and fails to correlate the sentiments of the users with the shared content. Further, these systems are not identifying or extracting any useful insights.

Further, some existing systems are configured for analysing the conversation based upon a relevancy score, impact score, influence score, and sentiment score. The relevancy score is computed for determining relevancy of the content to a forum topic or community. The impact score is calculated based on the change on frequency of messages before and after the message is posted or based on the users participating and their value or based on the relevance score. The influence score is calculated based on relevance, impact score and by adding a time component to it.

Therefore, there is long standing need of a system and method for determining a correlation between a content and a plurality of responses corresponding to the content shared on a communication platform.

### SUMMARY

This summary is provided to introduce concepts related to a system and a method for determining a correlation between a content shared on a communication platform and the concepts are further described below in the detailed description.

In one embodiment, a system for determining a correlation between a content and a plurality of responses corresponding to the content shared on a communication platform is disclosed. The system may comprise a processor and a memory coupled to the processor. The processor may be configured to execute a plurality of programmed instructions stored in the memory. The processor may execute one or more programmed instructions for receiving content, shared on a communication platform, and a plurality of responses corresponding to the content. The processor may further execute one or more programmed instructions for filtering a set of responses from the plurality of responses based upon interaction analysis of each user providing the response in view of prior engagement data and participation data on the communication platform, and content analysis corresponding to historical contents, on the communication platform, of each user providing the response. The processor may further execute one or more programmed instructions for extracting multidimensional behaviour data of the content and each response of the set of responses corresponding to the content. Further, the processor may execute one or more programmed instructions for performing an analysis on the multidimensional behaviour data of the content and the set of responses corresponding to the content. The processor may further execute one or more programmed instructions for computing an incoherence score corresponding to each individual response of the set of responses based upon the analysis of the multidimensional behaviour data. The incoherence score may be indicative of misalignment of each individual response of the set of responses and the content. The processor may be configured for computing an overall incoherence score based upon the incoherence score computed for each of the set of responses corresponding to the content. The overall incoherence score may be indicative of misalignment of the set of responses and the content. Further, the processor may execute one or more programmed instructions for deriving one or more insights indicative of variance between the content and the set of responses corresponding to the content and the set of responses corresponding to the content based upon one or more of the incoherence score, corresponding to each individual response of the set of responses, the overall incoherence score, the interaction analysis, and the content analysis of each user providing response.

In another embodiment, a method for determining a correlation between a content and a plurality of responses corresponding to the content shared on a communication platform is disclosed. The method may include receiving, via a processor, a content shared on a communication platform and a plurality of responses corresponding to the content. The method may further include filtering, via the processor, a set of responses from the plurality of responses based upon interaction analysis of each user providing the response in view of prior engagement data and participation data on the communication platform, and content analysis corresponding to historical contents, on the communication platform, of each user providing the response. The method may further include extracting, via the processor, multidimensional behaviour data of the content and each response of the set of responses corresponding to the content. The method may further include performing, via the processor, an analysis on the multidimensional behaviour data of the content and the set of responses corresponding to the content. The method may further include computing, via the processor, an incoherence score corresponding to each individual response of the set of responses based upon analysis of the multidimensional behaviour data. The incoherence score may be indicative of misalignment of each individual response and the content. The method may further include computing, via the processor, an overall incoherence score based upon the incoherence score computed for each of the set of responses corresponding to the content, wherein the overall incoherence score computed for each of the set of responses corresponding to the content. The overall incoherence score may be indicative of misalignment of the set of responses and the content. Further, the method may include deriving, via the processor, one or more insights indicative of variance between the content and the plurality of responses corresponding to the content based upon one or more of the incoherence score, corresponding to each individual response of the set of responses, the overall incoherence score, the interaction analysis, and the content analysis of each user providing response.

In yet another embodiment, a non-transitory medium storing program for determining for determining a correlation between a content and a plurality of responses corresponding to the content shared on a communication platform is disclosed. The program may include instructions for receiving a content shared on a communication platform and a plurality of responses corresponding to the content. The program may further include instructions for filtering a set of responses from the plurality of responses based upon interaction analysis of each user providing the response in view of prior engagement data and participation data on the communication platform, and content analysis corresponding to historical contents, on the communication platform, of each user providing the response. The program may further include instructions for extracting multidimensional behaviour data of the content and each response of the set of responses corresponding to the content. The program may further include instructions for performing an analysis on the multidimensional behaviour data of the content and the set of responses corresponding to the content. The program may further include instructions for computing an incoherence score corresponding to each individual response of the set of responses based upon the analysis of the multidimensional behaviour data. The incoherence score may be indicative of misalignment of each individual response and the content. The program may further include instructions for computing an overall incoherence score based upon the incoherence score computed for each of the set of responses corresponding to the content. The overall incoherence score may be indicative of misalignment of the set of responses and the content. Further, the program may include instructions for deriving one or more insights indicative of variance between the content and the plurality of responses corresponding to the content based upon one or more of the incoherence score, corresponding to each individual response of the set of responses, the overall incoherence score, the interaction analysis, and the content analysis of each user providing response.

### BRIEF DESCRIPTION OF DRAWINGS

The detailed description is described with reference to the accompanying Figures. In the Figures, the left-most digit(s) of a reference number identifies the Figure in which the reference number first appears. The same numbers are used throughout the drawings to refer like features and components.

FIG. 1 illustrates a network implementation of a system for determining a correlation between content and a plurality of responses corresponding to the content shared on a communication platform, in accordance with an embodiment of the present subject matter.

FIG. 2 illustrates a method for determining a correlation between a content and a plurality of responses corresponding to the content shared on a communication platform, in accordance with the embodiment of the present subject matter.

### DETAILED DESCRIPTION

Referenced throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

While aspects of described system and method for determining a correlation between a content and a plurality of responses corresponding to the content shared on a communication platform may be implemented in any number of different computing systems, environments, and/or configurations, the embodiments are described in the context of the following exemplary system.

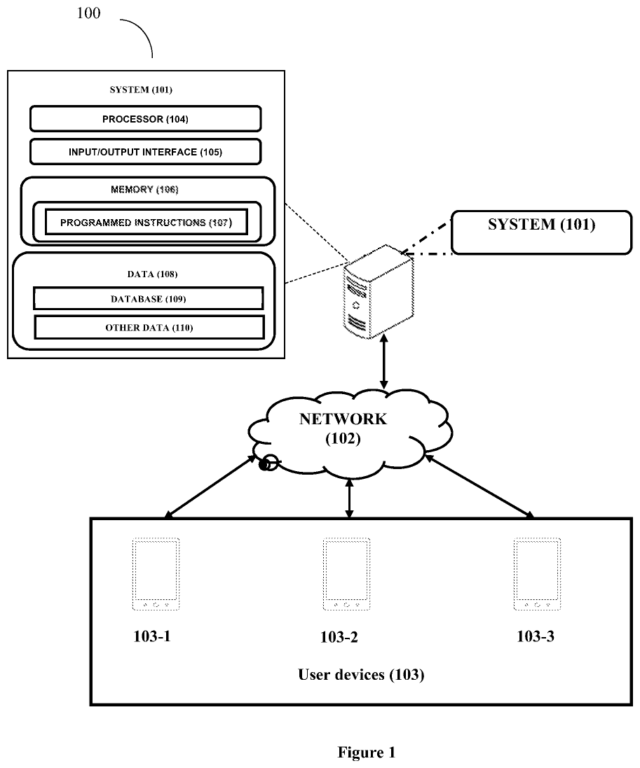

Referring now to FIG. 1, a network implementation 100 of a system 101 for determining the correlation between the content and the plurality of responses corresponding to the content shared on the communication platform is illustrated, in accordance with an embodiment of the present subject matter.

Although the present subject matter is explained considering that the system 101 is implemented on a server, it may be understood that the system 101 may also be implemented in a variety of computing systems, such as a laptop computer, a desktop computer, a notebook, a workstation, a mainframe computer, a server, a network server, and the like. It will be understood that the system 101 may be accessed by multiple users through one or more user devices 103-1, 103-2, 103-3, collectively referred to as user/user devices 103 hereinafter, or applications residing on the user devices 103. Examples of the user devices 103 may include, but are not limited to, a portable computer, a personal digital assistant, a handheld device, and a workstation. The user devices 103 are communicatively coupled to the system 101 through a network 102.

In one implementation, the network 102 may be a wireless network, a wired network or a combination thereof. The network 102 can be implemented as one of the different types of networks, such as intranet, local area network (LAN), wide area network (WAN), the internet, and the like. The network 102 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 102 may include a variety of network devices, including routers, bridges, servers, computing devices, storage devices, and the like.

Now, referring to FIG. 1, the components of the server (101) may include at least one processor (104), an input/output (I/O) interface (105), a memory (106), programmed instructions (107) and data (108). In one embodiment, the at least one processor (104) may be configured to fetch and execute computer-readable/programmed instructions (107) stored in the memory (106).

In one embodiment, the I/O interface (105) may be implemented as a mobile application or a web-based application and may further include a variety of software and hardware interfaces, for example, a web interface, a graphical user interface, image capturing means of the user device and the like. The I/O interface (105) may allow the server (101) to interact with the user devices (103). Further, the I/O interface (105) may enable the user device (103) to communicate with other computing devices, such as web servers and external data servers (not shown). The I/O interface (105) can facilitate multiple communications within a wide variety of networks and protocol types, including wired networks, for example, LAN, cable, etc., and wireless networks, such as WLAN, cellular, or satellite. The I/O interface (105) may include one or more ports for connecting to another server.

In an implementation, the memory (106) may include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and memory cards. The memory (106) may include programmed instructions (107) and data (108).

In one embodiment, the data (108) may comprise a database (109), and other data (110). The other data (110), amongst other things, serves as a repository for storing data processed, received, and generated by the one or more of the programmed instructions (107).

The aforementioned computing devices may support communication over one or more types of networks in accordance with the described embodiments. For example, some computing devices and networks may support communications over a Wide Area Network (WAN), the Internet, a telephone network (e.g., analog, digital, POTS, PSTN, ISDN, xDSL), a mobile telephone network (e.g., CDMA, GSM, NDAC, TDMA, E-TDMA, NAMPS, WCDMA, CDMA-2000, UMTS, 3G, 4G), a radio network, a television network, a cable network, an optical network (e.g., PON), a satellite network (e.g., VSAT), a packet-switched network, a circuit-switched network, a public network, a private network, and/or other wired or wireless communications network configured to carry data. Computing devices and networks also may support wireless wide area network (WWAN) communications services including Internet access such as EV-DO, EV-DV, CDMA/1×RTT, GSM/GPRS, EDGE, HSDPA, HSUPA, and others.

The aforementioned computing devices and networks may support wireless local area network (WLAN) and/or wireless metropolitan area network (WMAN) data communications functionality in accordance with Institute of Electrical and Electronics Engineers (IEEE) standards, protocols, and variants such as IEEE 802.11 (“WiFi”), IEEE 802.16 (“WiMAX”), IEEE 802.20x (“Mobile-Fi”), and others. Computing devices and networks also may support short range communication such as a wireless personal area network (WPAN) communication, Bluetooth® data communication, infrared (IR) communication, near-field communication, electromagnetic induction (EMI) communication, passive or active RFID communication, micro-impulse radar (MIR), ultra-wide band (UWB) communication, automatic identification and data capture (AIDC) communication, and others.

In one embodiment, the system (101) may be configured for receiving content shared on a communication platform and a plurality of responses corresponding to the content. In one embodiment, the user may use any communication platform to post his/her own content or share his/her views, or to participate in conversation on the content posted by others. In some exemplary embodiments, the communication platform may include a social networking platform prevalent in the art or an intranet platform where closed/limited set of users belonging to a particular organization users can communicate and/or exchange data.

The processor (201) may be configured for filtering a set of responses from the plurality of responses. The processor (201) may be configured for filtering the set of responses based upon interaction analysis of each user providing the response in view of prior engagement data and participation data on the communication platform and content analysis corresponding to historical contents, on the communication platform, of each user providing the response.

In one embodiment, the engagement data may include one or more of, but are not limited to, number of likes, number of reactions, frequency of posting content, time spent on the communication platform, and the like. In one embodiment, the participation data may include one or more of, but are not limited to, participation in one or more events, seminars, polls, and the like. Further, the engagement data and the participation data may be categorized into at least one of three groups selected from high, medium and low based upon level of interaction. The processor (104) may be further configured to determine the threshold for each aspect of each group such as number of likes etc., based upon historic data. Further, the processor (104) may be configured to change the threshold from time to time.

The content analysis corresponding to historical contents may include one or more of contents shared on the communication platform, emails, and browsing data. In one embodiment, the content shared by the individual user may be categorized based upon identification of the interest of the individual user. In one embodiment, the content shared by individual user on the communication platform may be categorized into at least one group selected from, but are not limited to, tactical, analytical, operational, and the like. In one embodiment, the emails may be categorized into at least one group selected from, but are not limited to, routine, new initiative, industry research, and the like. In one embodiment, browsing data may be categorized into at least one of a group selected from, but are not limited to research, operational, personal, general, and the like.

The processor (104) may be configured for extracting multidimensional behaviour data of the content and each response of the set of responses corresponding to the content. The multidimensional behaviour data may include, but are not limited to, sentiment data, emotion data, tone data, and the like. The multidimensional behaviour data may be extracted using at least one of extraction methods selected from a group comprising, but are not limited to, a rule based method, a machine learning method, a deep learning method, and a combination thereof.

In one embodiment, the content may be passed to a tone analyser in order to identify the tone which the content is portraying. The tones may include, but are not limited to aggressive, confident, joyful, analytical, and the like. Further, the content may be analysed on the document/sentence level sentiment analysis and the aspect based sentiment analysis. The document/sentence level sentiment analysis may help in identifying the overall sentiment crux as a positive sentiment, a negative sentiment or a neutral sentiment. The aspect based sentiment analysis may help in understanding what aspect of the sentiment/document comprises positive, negative and neutral. Further, the emotion analysis of the content may identify all emotions which are being conveyed by the written content.

The processor (104) may be configured for performing an analysis on the multidimensional behaviour data of the content and the set of responses corresponding to the content. The analysis of the multidimensional behaviour data may include step for determining probability distribution of the sentiment data, the tone data and the emotion data of the content.

In one exemplary embodiment, POS tagging and dependency parsing along with a known dictionary of words having polarities may be used for the sentiment analysis. In one case scenario, consider a sentence —“I used the product, but I did not like the interface. It's bad” may be broken into tokens. The tokens herein may include a list of words that constitute the sentence. Therefore, the word list for the said sentence may include—[‘I’, ‘used’, ‘the’, ‘product’, ‘but’, ‘I’, ‘did’, ‘not’, ‘like’, ‘the’, ‘interface’, ‘.’, ‘its’, ‘bad’]. The processor (201) may be configured to pre-process the text and remove the stop words such as “is” “and” “the” (as the stop words do not convey any polarity). Further, the processor (104) may perform lemmatization and stemming in order to provide the root words of all the words in the text. The pre-processed word list may include—[‘use’, ‘product’, ‘not’, ‘like’, ‘interface’, ‘bad’].

The rule based method may comprise dictionaries, wherein the dictionaries comprise positive word list, negative and neutral word list. In this method, zero positive words and negative words such as “not”, “bad” may be identified from the pre-processed words. In one embodiment, the probability distribution of a positive sentiment, a negative sentiment, and a neutral sentiment may be 0.0, 0.8 and 0.2 respectively.

In a deep learning based system, the word list may be converted into the vectors using bag of words or TFIDF vectorization. The vectors may be configured for capturing similarity between texts. The vectors may be passed as input to deep learning models along with true labels of whether they are positive sentiments or negative sentiments. The machine learning model learns the probability distribution of the positive and negative sentiment and when a new text is received, the machine learning model is enabled to classify the next text as a positive sentiment or a negative sentiment.

In one embodiment, the combination of rule based methods and deep learning based models may be used to further improve the accuracy. Further, similar process may be implemented for the generation of probability distribution of tone and emotion of the content.

In one exemplary embodiment, the response 1 of the set of responses may have following sentiment data:

Positive-0.2, Negative-0.8, Neutral-0.0

The response 2 of the set of responses may have following sentiment data:

Positive-0.1, Negative-0.7, Neutral-0.2

Further the analysis of the multidimensional behaviour data may include step for determining the depth of the sentiment data, the tone data and the emotion data for the set of responses by taking average of the summation of the probability distribution of the sentiment data, tone data and emotion data over the number of the set of responses corresponding to the content. In one exemplary embodiment, the depth of sentiment may be calculated as:

Positive=(0.2+0.1 . . . )/n

Negative=(0.8+0.7 . . . )/n

Neutral=(0.0+0.2 . . . )/n

Similarly, the depth of the tone data and emotion data may be calculated.

The processor (104) may be configured for computing an incoherence score corresponding to each individual response of the set of responses based upon analysis of the multidimensional behaviour data. In one embodiment, the incoherence is the measure of difference between the two probability distribution. The value for incoherence varies from range [0, √2]. The incoherence score may be indicative of misalignment of each individual response of the set of responses and the content.

The processor (104) may be configured for computing an overall incoherence score based upon the incoherence computed for each of the set of responses corresponding to the content. The overall incoherence score is indicative of misalignment of the set of responses and the content. In one embodiment, the individual incoherence score for each individual response of the set responses may be computed using Euclidean Distance as a measure of difference between the probability distribution of the sentiment data, the tone data and the emotion data of the content and the probability distribution of the sentiment data, the tone data and the emotion data of each response of the set of responses corresponding to the content.

In one exemplary embodiment, the incoherence score of the sentiment data may be calculated by performing following steps:

Step 1: Computing probability distribution of the sentiment data of the content—Point p1 (x1, y1, z1)

Wherein, Positive-0.6, Negative-0.25, Neutral-0.15 and

Computing probability distribution of the sentiment data of the responses—Point p2 (x2, y2, z2)

Wherein, Positive-0.3, Negative-0.55, Neutral-0.15

Step 2: Computing incoherence score of the sentiment data,

Wherein, incoherence score of the sentiment data=Euclidean Distance (p1,p2)=√(x2−x1)2+(y2−y1)2+(z2−z1)2

After substituting the values of x1, y1, z1 and x2, y2, z2 in the above equation, the Incoherence score of the Sentiment data is obtained as 0.42

Further, the incoherence score of the tone data may be calculated by performing following steps:

Step 1: Computing probability distribution of tone data of the content-Point p1 (a1, b1, c1, d1, e1, f1, g1),

Wherein, anger-0.05, fear-0.0, joy-0.25, sadness-0.0, analytical-0.30, confident-0.25, tentative-0.15 and

Computing probability distribution of tone data of the response—Point p2 (a2, b2, c2, d2, e2, f2, g2),

Wherein, anger-0.25, fear-0.05, joy-0.0, sadness-0.10, analytical-0.30, confident-0.15, tentative-0.15

Step 2: Computing incoherence score of the tone data,

Wherein, Incoherence score of the tone data=Euclidean Distance (p1,p2)=√(a2−a1)2+(b2−b1)2+(c2−c1)2+(d2−d1)2+(e2−e1)2+(f2−f1)2+(g2−g1)2

After inserting the values of a1, b1, c1, d1, e1, f1, g1 and a2, b2, c2, d2, e2, f2, g2 in the above equation, the Incoherence score of the tone data may be obtained as 0.353.

Further, the incoherence of the emotion data may be calculated by performing following steps:

Step 1: Computing probability distribution of emotion data of the content—Point p1 (a1, b1, c1, d1, e1, f1, g1, h1, i1)

Wherein, Joy-0.50, Sadness-0.0, Fear-0.0, Disgust-0.0, Anger-0.0, Surprise-0.15, Love-0.10, Pride-0.25, Shame-0.0 and

Computing probability distribution of emotion data of the responses—Point p2 (a2, b2, c2, d2, e2, f2, g2, h2, i2)

Wherein, joy-0.10, sadness-0.15, fear-0.0, disgust-0.0, Anger-0.35, Surprise-0.15, Love-0.0, Pride-0.25, Shame-0.0.

Step 2: Computing incoherence score of emotion data,

Wherein, incoherence score of the emotion data=Euclidean Distance (p1,p2)=√(a2−a1)2+(b2−b1)2+(c2−c1)2+(d2−d1)2+(e2−e1)2+(f2−f1)2+(g2−g1)2+(h2−h1)2+(i2−i1)2

After substituting values of a1, b1, c1, d1, e1, f1, g1, h1, i1 and a2, b2, c2, d2, e2, f2, g2, h2, i2 in the above equation, the Incoherence score of the emotion data is obtained as 0.561

Now, with the individual incoherence score, the overall incoherence score may be computed as below:

Incoherence score of the sentiment data=0.42

Incoherence score of the tone data=0.353

Incoherence score of the emotion data=0.561

$$The overall incoherence score = ( incoherence score of the sentiment data + incoherence score of the tone data + incoherence score of the emotion data ) \text{/} 3 = ( 0.42 + 0.353 + 0.561 ) \text{/} 3 = 0.444$$

Therefore, the overall incoherence score of the content and set of responses may be 0.444, wherein the incoherence varies from 0 to √2 inclusive of both values.

The overall incoherence score may be indicative of misalignment between the content and the set of responses.

The processor (104) may be configured for deriving one or more insights indicative of variance between the content and the set of responses corresponding to the content based upon one or more of the incoherence score, corresponding to each individual response of the set of responses, the overall incoherence score, the interaction analysis, and the content analysis of the each user providing response.

In one embodiment, the one or more insights may include an identification of an improvement areas, a context and an audience or a group of users.

In one embodiment, the identification of improvement areas may be useful in next decision step. In one exemplary embodiment, consider a content shared by an organization may include a text “Our philosophy on Diversity is to Include and Impact. We believe different perspectives help us all to achieve more. By bringing people for diverse backgrounds and letting them work together creates a more positive and efficient environment”. In this exemplary embodiment, consider a response 1 to this content may include a text “I believe it does create a positive environment but don't agree on the efficient part. Having diverse backgrounds sometimes creates a communication gap”. Further, in this exemplary embodiment, consider a response 2 to this content may include a text “I agree completely having Diverse culture is a must for a Company”. In this exemplary embodiment, the system may provide report comprising positive aspect-Diverse culture (0.7), positive environment (0.5) and negative aspects-efficient environment (0.67).

In one embodiment, the context may be multidimensional attribute. The context may include, but are not limited to, a geography, the group of users, the content, time when content was shared, project on which associate/employee is working and keywords which are not part of the content. In one embodiment, frequently used keywords, hashtags, mentions may be cross checked with the keywords used in the original content in order to identify new keywords which are not part of the content. In one exemplary embodiment, consider the content shared on the communication platform may include “Lets go out and eat. I recommend you all to try my eating adventure. Follow the map and visit all the places in the order and eat the dishes what I have mentioned. Believe me you are in for a delicious trip of your life.” In this exemplary embodiment, consider a response 1 to this content may include “Please don't encourage people to go out and eat during this pandemic. It's not safe #covid19 #stayindoors #staysafe”. Further, in this exemplary embodiment, consider a response 12 may include “I don't share the same view. The foods you mentioned are Junk mate and they are extremely unhealthy. Going on this trip I will come back 10 pounds heavier.” In this exemplary embodiment, the system (101) may compute the keyword difference between the content shared and the plurality of responses on it. The most frequent keywords are used from the overall responses. The system (101) may identify the keyword difference—#covid, #stayindoors, #staysafe, unhealthy. The keyword difference may help in identifying the context which is missing in the content and may help in taking the further decisions.

In one embodiment, the system (101) may use the information, attributes of the audience for context. Further, the system (101) may also group the set of responses on the basis of its origin geography.

In one embodiment, the system (101) may identify the people or audience who have most coherent views with respect to the content and who have most incoherent views for the content. The identification of the audience may help identification of two group of people. The group of people whose responses are in coherence with the content shared are supporters and group of people whose responses are incoherent with the content shared are opposers. Further, the system (101) may identify the people with high interaction, medium interaction and low interaction using the interaction analysis.

Further, the system (101) may identify interest areas of the employee/associate based upon an information generated from the content analysis corresponding to historical content such as browsing history, emails and content shared by associate on the communication platform. Further, the information generated by content analysis may be used for cultivating customized growth plan for an individual to drive the employee/associate towards his interest aligned to the values of the organization. This may improve the employee retention ratio and may also improve the productivity. In one embodiment, the system (101) may monitor the change in behaviour of the employee/associate over time, month by month or quarterly basis using multidimensional behaviour data. This may help to identify whether changes made to improve the alignment are working or not. In one embodiment, the system (101) may configured for recommending the associate/employee on what can they do to improve their alignment with the leadership thinking by considering the interest areas of the associate/employee.

In one exemplary embodiment, the system (101) may be implemented in an organization to derive insights for associates and leadership on the content shared by the organization. The content shared by the organization may include post shared by the organization on an internal communication platform. The post is new initiative for developing something new (an idea, product, service, technology, process, and strategy) for an organization and preparing the team of the most suitable members for the task. The system (101) may be configured to receive the content of the post and the plurality of responses corresponding to the content from a plurality of employees. The system (101) may be configured for filtering the set of responses from the plurality of responses. The filtering of the set of responses from the plurality of responses may be based upon the interaction analysis of each user and content analysis corresponding to historical contents. The interaction analysis may comprise prior engagement data such as number of likes, reactions, frequency of posting content on the communication platform, time spent on the communication platform and participation data such as participation of the employee in the event which is conducted by the organization. The content analysis corresponding to historical content may comprise one or more of contents shared on the communication platform, emails, and browsing data which is indicative of the inclination of the employee towards the research or innovation. Suppose the set of employee has tendency to search research related news or topics, exchanging emails on research topics, and actively participating in research based seminars then responses of such employees are considered as the set of responses for the further processing of data. Further, the system (101) may extract sentiment data, tone data and emotion data of the content and each response of the set of responses corresponding to the content. The system (101) may perform the analysis on the sentiment data, tone data and emotion data of the content and the set of responses corresponding to the content. The system (101) may compute the incoherence score corresponding to each individual response of the set of responses based upon the analysis of the sentiment data, tone data and emotion data of the content and the set of responses corresponding to the content. The system (101) may compute an overall incoherence score based upon the incoherence score computed for each of the set of responses corresponding to the content. The overall incoherence score may be indicative of misalignment of the set of responses and the content. The system (101) may derive insights for associates and leadership on the content shared by the organization based upon one or more of the incoherence score, corresponding to each individual response of the set of responses, the overall incoherence score, the interaction analysis, and the content analysis of each user providing response.

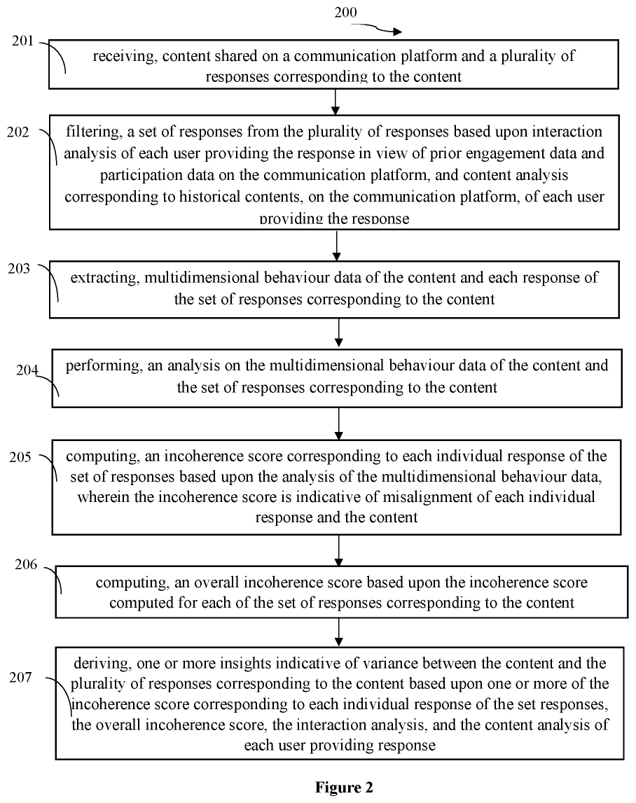

Now referring to FIG. 2, a method for determining a correlation between a content and a plurality of responses corresponding to the content shared on a communication platform is depicted, in accordance with an embodiment of the present disclosure.

At step 201, the processor (104) may be configured for receiving content shared on the communication platform and the plurality of responses corresponding to the content.

At step 202, the processor (104) may be configured for filtering a set of responses from the plurality of responses based upon interaction analysis of each user providing the response in view of prior engagement data and participation data on the communication platform, and content analysis corresponding to historical contents, on the communication platform, of each user providing the response.

At step 203, the processor (104) may be configured for extracting multidimensional behaviour data of the content and each response of the set of responses corresponding to the content.

At step 204, the processor (104) may be configured for performing an analysis on the multidimensional behaviour data of the content and the set of responses corresponding to the content.

At step 205, the processor (104) may be configured for computing an incoherence score corresponding to each individual response of the set of responses based upon the analysis of the multidimensional behaviour data. The incoherence score may be indicative of misalignment of each individual response and the content.

At step 206, the processor (104) may be configured for computing the overall incoherence score based upon the incoherence score computed for each of the set of responses corresponding to the content.

At step 207, the processor (104) may be configured for deriving one or more insights indicative of variance between the content and the plurality of responses corresponding to the content based upon one or more of the incoherence score corresponding to each individual response of the set responses, the overall incoherence score, the interaction analysis, and the content analysis of the each user providing response.

What is claimed is:

1. A system for determining a correlation between a content and a plurality of responses corresponding to the content shared on a communication platform, wherein the system comprising:
a processor; and
a memory, wherein the processor is configured to execute instructions stored in the memory for
receiving content, shared on a communication platform, and a plurality of responses corresponding to the content;
filtering a set of responses from the plurality of responses based upon
interaction analysis of each user providing the response in view of prior engagement data and participation data on the communication platform, and
content analysis corresponding to historical contents, on the communication platform, of each user providing the response;
extracting multidimensional behaviour data of the content and each response of the set of responses corresponding to the content;
performing an analysis on the multidimensional behaviour data of the content and the set of responses corresponding to the content;
computing an incoherence score corresponding to each individual response of the set of responses based upon the analysis of the multidimensional behaviour data, wherein the incoherence score is indicative of misalignment of each individual response of the set of responses and the content;
computing an overall incoherence score based upon the incoherence score computed for each of the set of responses corresponding to the content, wherein the overall incoherence score is indicative of misalignment of the set of responses and the content; and
deriving one or more insights indicative of variance between the content and the set of responses corresponding to the content based upon one or more of the incoherence score, corresponding to each individual response of the set of responses, the overall incoherence score, the interaction analysis, and the content analysis of each user providing response.

2. The system as claimed in claim 1, wherein the engagement data comprises one or more of number of likes, number of reactions, frequency of posting contents, time spent on the communication platform, and wherein the participation data comprises one or more of participation in one or more events, seminars and polls.

3. The system as claimed in claim 1, wherein the historical contents comprise one or more of contents shared on the communication platform, emails, and browsing data.

4. The system as claimed in claim 1, wherein the multidimensional behaviour data comprises sentiment data, emotion data and tone data, and wherein the multidimensional behaviour data is extracted using at least one of extraction methods selected from a comprising a rule based method, a machine learning method, a deep learning method, and a combination thereof.

5. The system as claimed in claim 4, wherein the analysis of the multidimensional behaviour data includes steps for:
determining probability distribution of the sentiment data, the tone data and the emotion data of the content;
determining probability distribution of the sentiment data, the tone data and the emotion data of each response of the set of responses corresponding to the content; and
determining the depth of the sentiment data, the tone data and the emotion data for the set of responses by taking average of the summation of the probability distribution of the sentiment data, tone data and emotion data over the number of the set of responses corresponding to the content.

6. The system as claimed in claim 5, wherein the individual incoherence score for each individual response of the set responses is computed using Euclidean Distance as a measure of difference between the probability distribution of the sentiment data, the tone data and the emotion data of the content and the probability distribution of the sentiment data, the tone data and the emotion data of each response of the set of responses corresponding to the content.

7. The system as claimed in claim 5, wherein the overall incoherence score is computed using Euclidean Distance as a measure of difference between the probability distribution of the sentiment data, the tone data and the emotion data of the content and the depth of the sentiment data, the tone data and the emotion data for the set of responses.

8. The system as claimed in claim 1, wherein the one or more insights comprises an identification of an improvement areas, a context and an audience or a group of users, wherein the context comprises a geography, the group of users, the content, and keywords which are not part of the content.

9. A method for determining for determining a correlation between a content and a plurality of responses corresponding to the content shared on a communication platform, the method comprising:
receiving, via a processor, content shared on a communication platform and a plurality of responses corresponding to the content;
filtering, via the processor, a set of responses from the plurality of responses based upon
interaction analysis of each user providing the response in view of prior engagement data and participation data on the communication platform, and
content analysis corresponding to historical contents, on the communication platform, of each user providing the response;
extracting, via the processor, multidimensional behaviour data of the content and each response of the set of responses corresponding to the content;
performing, via the processor, an analysis on the multidimensional behaviour data of the content and the set of responses corresponding to the content;
computing, via the processor, an incoherence score corresponding to each individual response of the set of responses based upon the analysis of the multidimensional behaviour data, wherein the incoherence score is indicative of misalignment of each individual response and the content;
computing, via the processor, an overall incoherence score based upon the incoherence score computed for each of the set of responses corresponding to the content, wherein the overall incoherence score is indicative of misalignment of the set of responses and the content; and
deriving, via the processor, one or more insights indicative of variance between the content and the plurality of responses corresponding to the content based upon one or more of the incoherence score corresponding to each individual response of the set responses, the overall incoherence score, the interaction analysis, and the content analysis of each user providing response.

10. The method as claimed in claim 9, wherein the engagement data comprises one or more of number of likes, number of reactions, frequency of posting contents, time spent on the communication platform, and wherein the participation data comprises one or more of participation in one or more events, seminars and polls.

11. The method as claimed in claim 9, wherein historical contents comprise one or more of contents shared on the communication platform, emails, and browsing data.

12. The method as claimed in claim 9, wherein the multidimensional behaviour data comprises sentiment data, emotion data and tone data, and wherein the multidimensional behaviour data is extracted using at least one of extraction methods selected from a comprising a rule based method, a machine learning method, a deep learning method, and a combination thereof.

13. The method as claimed in claim 12, wherein the analysis of the multidimensional behaviour data includes steps for:
determining, via the processor, probability distribution of the sentiment data, the tone data and the emotion data of the content;
determining, via the processor, probability distribution of the sentiment data, the tone data and the emotion data of each response of the set of responses corresponding to the content; and
determining, via the processor, the depth of the sentiment data, the tone data and the emotion data for the set of responses by taking average of the summation of the probability distribution of the sentiment data, tone data and emotion data over the number of the set of responses corresponding to the content.

14. The method as claimed in claim 13, wherein the individual incoherence score for each individual response is computed using Euclidean Distance as a measure of difference between the probability distribution of the sentiment data, the tone data and the emotion data of the content and the probability distribution of the sentiment data, the tone data and the emotion data of each response of the set of responses corresponding to the content.

15. The method as claimed in claim 13, wherein the overall incoherence score is computed using Euclidean Distance as a measure of difference between the probability distribution of the sentiment data, the tone data and the emotion data of the content and the depth of the sentiment data, the tone data and the emotion data for the set of the responses.

16. The method as claimed in claim 9, wherein the one or more insights comprises an identification of an improvement areas, a context and an audience or a group of users, wherein the context comprises a geography, the group of users, the content, and keywords which are not part of the content.

17. A non-transitory medium storing program for determining for determining a correlation between a content and a plurality of responses corresponding to the content shared on a communication platform, the program comprising instructions for:
receiving a content shared on a communication platform and a plurality of responses corresponding to the content;
filtering a set of responses from the plurality of responses based upon
interaction analysis of each user providing the response in view of prior engagement data and participation data on the communication platform, and
content analysis corresponding to historical contents, on the communication platform, of each user providing the response;
extracting multidimensional behaviour data of the content and each response of the set of responses corresponding to the content;
performing an analysis on the multidimensional behaviour data of the content and the set of responses corresponding to the content;
computing an incoherence score corresponding to each individual response of the set of responses based upon the analysis of the multidimensional behaviour data, wherein the incoherence score is indicative of misalignment of each individual response and the content;
computing an overall incoherence score based upon the incoherence score computed for each of the set of responses corresponding to the content, wherein the overall incoherence score is indicative of misalignment of the set of responses and the content; and
deriving one or more insights indicative of variance between the content and the plurality of responses corresponding to the content based upon one or more of the incoherence score corresponding to each individual response of the set responses, the overall incoherence score, the interaction analysis, and the content analysis of each user providing response.

18. The non-transitory medium as claimed in claim 17, wherein the analysis of the multidimensional behaviour data include instructions for:
determining probability distribution of the sentiment data, the tone data and the emotion data of the content;
determining probability distribution of the sentiment data, the tone data and the emotion data of each response of the set of responses corresponding to the content;
determining the depth of the sentiment data, the tone data and the emotion data for the set of responses by taking average of the summation of the probability distribution of the sentiment data, tone data and emotion data over the number of the set of responses corresponding to the content.
